(19) United States
(12) Patent Application Publication
(10) Pub. No.: US 2025/0095588 A1
(43) Pub. Date: Mar. 20, 2025

(54) DISPLAY PANEL AND DISPLAY DEVICE

(71) Applicants: Chengdu BOE Optoelectronics Technology Co., Ltd., Chengdu, Sichuan (CN); BOE Technology Group Co., Ltd., Beijing (CN)

(72) Inventors: Mengqi WANG, Beijing (CN); Miao WANG, Beijing (CN); Jingwen ZHANG, Beijing (CN); Gukhwan SONG, Beijing (CN); Haigang QING, Beijing (CN); Hong YI, Beijing (CN)

(73) Assignees: Chengdu BOE Optoelectronics Technology Co., Ltd., Chengdu, Sichuan (CN); BOE Technology Group Co., Ltd., Beijing (CN)

(21) Appl. No.: 18/018,880

(22) PCT Filed: Jan. 29, 2022
(86) PCT No.: PCT/CN2022/075038

§ 371 Date: Jan. 31, 2023

(51) Int. Cl. G09G 3/3266

(52) U.S. Cl. CPC G09G 3/3266; G09G 2320/0233

(57) ABSTRACT

Provided is a display panel including: a substrate, including a display region and a GOA region at least partially surrounding the display region; a plurality of pixels arranged in arrays, disposed in the display region; a first GOA circuit, disposed in the GOA region, wherein the first GOA circuit includes a plurality of cascaded first GOA units, each of the first GOA units being coupled to at least one row of the pixels and being configured to transmit a gate drive signal to the at least one row of the pixels; and a second GOA circuit, disposed in the GOA region, wherein the second GOA circuit includes a plurality of cascaded second GOA units, each of the second GOA units being coupled to at least one row of the pixels and being configured to transmit a light emission control signal to the at least one row of the pixels.

### CROSS-REFERENCE TO RELATED APPLICATION

The present disclosure is a U.S. national stage of international application No. PCT/CN2022/075038, filed on Jan. 29, 2022, the content of which is herein incorporated by reference in its entirety.

### TECHNICAL FIELD

The present disclosure relates to the technical filed of displays, and in particular, relates to a display panel and a display device.

### BACKGROUND

Active-matrix organic light-emitting diode (AMOLED) display panels are widely used in various display devices because of advantages such as self-illumination, high response speed, high contrast ratio, and wide view angle.

### SUMMARY

Embodiments of the present disclosure provide a display panel and a display device. The technical solutions are as follows.

According to one aspect of the embodiments of the present disclosure, a display panel is provided. The display panel includes:
a substrate, including a display region and a gate driver on array (GOA) region at least partially surrounding the display region;
a plurality of pixels arranged in arrays, disposed in the display region;
a first GOA circuit, disposed in the GOA region, wherein the first GOA circuit includes a plurality of cascaded first GOA units, each of the first GOA units being coupled to at least one row of the pixels and being configured to transmit a gate drive signal to the at least one row of the pixels; and
a second GOA circuit, disposed in the GOA region, wherein the second GOA circuit includes a plurality of cascaded second GOA units, each of the second GOA units being coupled to at least one row of the pixels and being configured to transmit a light emission control signal to the at least one row of the pixels;
wherein at least one of the first GOA units and at least one of the second GOA units are respectively disposed on two sides of a plurality of rows of the pixels in a row direction; and each of the pixel is configured to emit light in response to the received gate drive signal and the received light emission control signal.

In some embodiments, in the plurality of first GOA units, a portion of the first GOA units are disposed on a first side of the two sides, and the first GOA units other than the portion of the first GOA units are disposed on a second side of the two sides; and
in the plurality of second GOA units, a portion of the second GOA units are disposed on the first side, and the second GOA units other than the portion of the second GOA units are disposed on the second side.

In some embodiments, each of the first GOA units is coupled to a row of the pixels;
wherein in the plurality of first GOA units, each of the first GOA units coupled to an even row of the pixels is disposed on the first side, and each of the first GOA units coupled to an odd row of the pixels is disposed on the second side.

In some embodiments, each of the second GOA units is coupled to a row of the pixels:
wherein in the plurality of second GOA units, each of the second GOA units coupled to an odd row of the pixels is disposed on the first side, and each of the second GOA units coupled to an even row of the pixels is disposed on the second side.

In some embodiments, each of the first GOA units and each of the second GOA units that are disposed on the first side are successively arranged in a column direction in an order of one first GOA unit followed by one second GOA unit; and
each of the first GOA units and each of the second GOA units that are disposed on the second side are successively arranged in the column direction in an order of one second GOA unit followed by one first GOA unit.

In some embodiments, each of the second GOA units is coupled to a group of the pixels, wherein the group of the pixels includes two rows of the pixels:
wherein in the plurality of second GOA units, each of the second GOA units coupled to an odd group of the pixels are disposed on the first side, and each of the second GOA units coupled to an even group of the pixels are disposed on the second side.

In some embodiments, the group of the pixels includes two adjacent rows of the pixels.

In some embodiments, each of the first GOA units and each of the second GOA units that are disposed on the first side are successively arranged in a column direction in an order of one second GOA unit followed by two first GOA units; and
each of the first GOA units and each of the second GOA units that are disposed on the second side are successively arranged in the column direction in an order of two first GOA units followed by one second GOA units.

In some embodiments, each of the first GOA units includes two first output terminals, wherein one of the first output terminals is coupled to a row of the pixels, and the other of the first output terminals is coupled to one of the cascaded first GOA units; and
each of the second GOA units includes a second output terminal, wherein the second output terminal is coupled to a row of the pixels and one of the cascaded second GOA units.

In some embodiments, each of the pixels includes an N-type transistor and a P-type transistor; and the first GOA circuit further includes: a plurality of cascaded third GOA units; wherein
each of the first GOA units is coupled to the P-type transistor in each of the pixels of the at least one row of the pixels and is configured to transmit a first gate drive signal to the P-type transistor; and
each of the third GOA units is coupled to the N-type transistor in each of the pixels of the at least one row of the pixels and is configured to transmit a second gate drive signal to the N-type transistor.

In some embodiments, a size of the third GOA unit and a size of the second GOA unit are the same, and are both greater than a size of the first GOA unit; and
the plurality of second GOA units and the plurality of third GOA units are disposed on a first side of the two sides, and the plurality of first GOA units are disposed on a second side of the two sides.

In some embodiments, each of the second GOA units is coupled to a row of the pixels, and each of the third GOA units is coupled to a row of the pixels; and
the second GOA units and the third GOA units that are coupled to a same row of the pixels are successively arranged along the row direction.

In some embodiments, each of the second GOA units is coupled to two rows of the pixels, and each of the third GOA units is coupled to two rows of the pixels; and
each of the second GOA units and each of the third GOA units that are disposed on the first side are successively arranged in a column direction in an order of one second GOA unit followed by one third GOA unit.

In some embodiments, each of the second GOA units is coupled to two adjacent rows of the pixels, each of the third GOA units is coupled to two adjacent rows of the pixels, and each adjacent one of the second GOA units and one of the third GOA units are coupled to the same two rows of the pixels.

In some embodiments, the second GOA unit and the third GOA unit both include: a drive transistor and an output transistor;
wherein the drive transistor is coupled to the output transistor, and the output transistor is coupled to the pixel; and the drive transistor is configured to control the output transistor to transmit a signal to the pixel; and
wherein a channel width-length ratio of the output transistor is greater than a channel width-length ratio of the drive transistor.

In some embodiments, the channel width-length ratio of the output transistor is twice the channel width-length ratio of the drive transistor.

In some embodiments, in each of the pixels, the N-type transistor is made of an oxide material, and the P-type transistor is made of a low-temperature polysilicon (LTPS) material.

In some embodiments, the plurality of cascaded first GOA units are coupled to a first start signal terminal and are configured to transmit, in response to a first start signal transmitted by the first start signal terminal, the first gate drive signal to the plurality of rows of the pixels;
the plurality of cascaded second GOA units are coupled to a second start signal terminal and are configured to transmit, in response to a second start signal transmitted by the second start signal terminal, the light emission control signal to the plurality of rows of the pixels; and
the plurality of cascaded third GOA units are coupled to a third start signal terminal and are configured to transmit, in response to a second start signal transmitted by the third start signal terminal, the second gate drive signal to the plurality of rows of the pixels.

In some embodiments, the display panel further includes:
a plurality of first gate lines, a plurality of second gate lines, and a plurality of light emission control lines, which are disposed in the display region;
wherein each of the first GOA units is coupled to a row of the pixels by one of the first gate lines, each of the second GOA units is coupled to a row of the pixels by one of the light emission control lines, and each of the third GOA units is coupled to a row of the pixels by one of the second gate lines.

According to another aspect of the embodiments of the present disclosure, a display device is provided. The display device includes: a power supply component and the display panel as described above;
wherein the power supply component is coupled to the display panel and is configured to supply power to the display panel.

### BRIEF DESCRIPTION OF THE DRAWINGS

For clearer descriptions of the technical solutions in the embodiments of the present disclosure, the following briefly introduces the accompanying drawings required for describing the embodiments. Apparently, the accompanying drawings in the following description show merely some embodiments of the present disclosure, and a person of ordinary skill in the art may still derive other drawings from these accompanying drawings without creative efforts.

FIG. 1 is a schematic structural diagram of a display panel according to some embodiments of the present disclosure;

FIG. 2 is a schematic structural diagram of another display panel according to some embodiments of the present disclosure;

FIG. 3 is a schematic structural diagram of still another display panel according to some embodiments of the present disclosure;

FIG. 4 is a schematic structural diagram of still another display panel according to some embodiments of the present disclosure;

FIG. 5 is a structural layout of a display panel using the structure illustrated in FIG. 3 as an example;

FIG. 6 is a structural layout of another display panel using the structure illustrated in FIG. 4 as an example;

FIG. 7 is a structural layout of an active layer in the structural layout illustrated in FIG. 6;

FIG. 8 is a structural layout of a first gate metal layer in the structural layout illustrated in FIG. 6;

FIG. 9 is a structural layout of a second gate metal layer in the structural layout illustrated in FIG. 6;

FIG. 10 is a structural layout of a first source-drain metal layer in the structural layout illustrated in FIG. 6;

FIG. 11 is a structural layout of a second source-drain metal layer in the structural layout illustrated in FIG. 6;

FIG. 12 is a schematic structural diagram of still another display panel according to some embodiments of the present disclosure;

FIG. 13 is a schematic structural diagram of still another display panel according to some embodiments of the present disclosure;

FIG. 14 is a schematic structural diagram of still another display panel according to some embodiments of the present disclosure; and

FIG. 15 is a schematic structural diagram of a display device according to some embodiments of the present disclosure.

### DETAILED DESCRIPTION

The present disclosure is described in further detail with reference to the accompanying drawings, to clearly present the objects, technical solutions, and advantages of the present disclosure.

The terms used in the detailed description of the present disclosure are merely for interpreting, instead of limiting, the embodiments of the present disclosure. It should be noted that unless otherwise defined, technical or scientific terms used in the embodiments of the present disclosure shall have ordinary meanings understandable by persons of ordinary skill in the art to which the disclosure belongs. The terms “first,” “second,” and the like used in the embodiments of the present disclosure are not intended to indicate any order, quantity, or importance, but are merely used to distinguish the different components. The terms “comprise,” “include,” and derivatives or variations thereof are used to indicate that the element or object preceding the terms covers the element or object following the terms and its equivalents and shall not be understood as excluding other elements or objects. The terms “connect,” “contact,” and the like are not intended to be limited to physical or mechanical connections, but may include electrical connections, either direct or indirect connection. The terms “on,” “under,” “left,” and “right” are only used to indicate the relative positional relationship. When the absolute position of the described object changes, the relative positional relationship may change accordingly. The term “connected to,” or “coupled to” indicates an electrical connection. The term “and/or” indicates three relationships between contextual objects. For example, A and/or B may indicate that A exists alone, A and B exist at the same time, and B exists alone. The symbol “/” generally denotes an “OR” relationship between contextual objects.

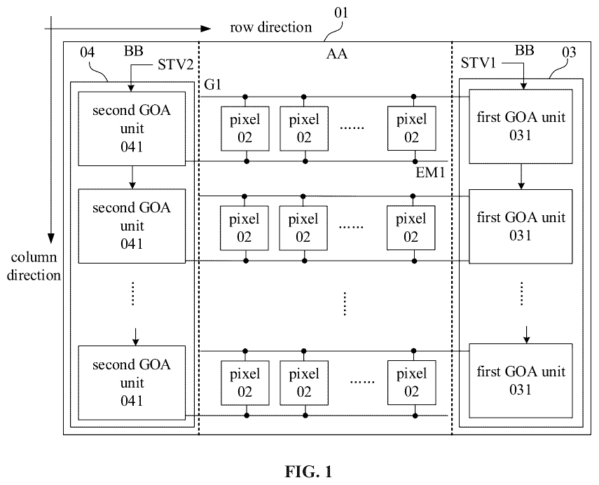

FIG. 1 is a schematic structural diagram of a display panel 00 according to some embodiments of the present disclosure. As illustrated in FIG. 1, the display panel 00 includes: a substrate 01, wherein the substrate 01 includes a display region AA and a gate driver on array (GOA) region BB at least partially surrounding the display region AA. Referring to FIG. 1, in the substrate 01 illustrated therein, the GOA region partially surrounds the display region AA and is disposed on left and right sides of the display region AA. In other embodiments, the GOA region is disposed on an upper side and/or a lower side of the display region AA. Alternatively, the GOA region surrounds the display region AA, that is, the display region AA is surrounded by the GOA region.

Still referring to FIG. 1, the display panel according to some embodiments of the present disclosure further includes: a plurality of pixels 02 disposed in the display region AA and arranged in arrays. The term “arranged in arrays,” indicates that the plurality of pixels 02 are arranged in a row direction and a column direction. That is, the display panel includes a plurality of rows and columns of pixels illustrated in FIG. 1. The display panel further includes: a first GOA circuit 03 and a second GOA circuit 04 that are disposed in the GOA region BB.

The first GOA circuit 03 includes a plurality of cascaded first GOA units 031. Each of the first GOA units 031 is coupled to at least one row of pixels and is configured to transmit a gate drive signal to a row of pixels. Accordingly, the first GOA circuit 03 is referred to as a gate drive circuit, that is, a Gate GOA circuit. For example, each of the first GOA units 031 illustrated in FIG. 1 is coupled to a row of pixels.

The second GOA circuit 04 includes a plurality of cascaded second GOA units 041. Each of the second GOA units 041 is coupled to at least one row of pixels and is configured to transmit a light emission (EM) control signal to at least one row of pixels. Accordingly, the second GOA circuit 04 is referred to as a light emission control circuit, that is, an EM GOA circuit. For example, each of the second GOA units 041 illustrated in FIG. 1 is coupled to a row of pixels.

Each of the pixels 02 is configured to emit light in response to the received gate drive signal and the received light emission control signal.

It should be noted that, referring to FIG. 1, using the first GOA unit 031 as an example, the term “cascaded” indicates that: two (also referred to as two stages) of the first GOA units 031 are coupled to each other, and the latter stage first GOA unit 031 operates under a drive of the former stage first GOA unit 031. Moreover, the two coupled first GOA units 031 either are adjacent to each other as illustrated in FIG. 1 or not. The plurality of second GOA units 041 are cascaded in the same way, which is not repeated herein. In addition, each of the first GOA units 031 is coupled to different rows of pixels, and each of the second GOA units 041 is coupled to different rows of pixels.

In some embodiments of the present disclosure, at least one of the first GOA units 031 and at least one of the second GOA units 041 are respectively disposed on two sides of the plurality of rows of pixels in the row direction. That is, referring to FIG. 1, one or more of the first GOA units 031 and one or more of the second GOA units are respectively disposed on a left side and a right side of the display region AA. In this way, compared with the Gate GOA circuit and the EM GOA circuit being arranged on a same side in the related art, the Gate GOA circuit and the EM GOA circuit according to some embodiments of the present disclosure are in dispersed layout, and thus, wiring is accordingly simplified, and a screen-to-body ratio of the display panel is improved, which facilitates a narrow frame design of a display device. On the premise of facilitating the narrow frame design, a solid foundation is also laid for a full-screen design of the display device.

In summary, some embodiments of the present disclosure provide a display panel. The display panel includes: a substrate including a display region and a GOA region, a plurality of pixels disposed in the display region, and a first GOA circuit and a second GOA circuit that are disposed in the GOA region. The plurality of first GOA units included in the first GOA circuit and the plurality of second GOA units included in the second GOA circuit are respectively coupled to a plurality of rows of pixels to drive the plurality of rows of pixels to emit light. At least one of the first GOA units and at least one of the second GOA units are respectively disposed on two sides of the plurality of rows of pixels in a row direction. Therefore, the layout is simplified to ensure that the screen-to-body ratio of the display panel is great, which facilitates the narrow frame design of the display device.

Optionally, referring to FIG. 1, the display panel 00 according to some embodiments of the present disclosure further includes: a plurality of first gate lines G1 and a plurality of light emission control lines EM1 that are disposed in the display region AA.

Each of the first GOA units 031 is coupled to a row of pixels by one of the first gate lines G1. Each of the second GOA units 041 is coupled to a row of pixels by one of the light emission control lines EM1. Accordingly, each of the first GOA units 031 transmits a gate drive signal to the pixel 02 by the first gate line G1, and each of the second GOA units 041 transmits a light emission control signal to the pixel 02 by the light emission control line EM1.

The plurality of cascaded first GOA units 031 are coupled to a first start signal terminal STV1 and are configured to transmit, in response to a first start signal transmitted by the first start signal terminal STV1, a first gate drive signal to the plurality of rows of pixels. The plurality of cascaded second GOA units 041 are coupled to a second start signal terminal STV2, and are configured to transmit, in response to a second start signal transmitted by the second start signal terminal STV2, the light emission control signal to the plurality of rows of pixels. That is, the first GOA circuit 03 and the second GOA circuit 04 operate in response to different start signals. To facilitate the wiring, referring to FIG. 1, a first first GOA unit 031 coupled to a first row of pixels is typically coupled to the first start signal terminal STV1. Similarly, a first second GOA unit 041 coupled to the first row of pixels is coupled to the second start signal terminal STV2.

Optionally, in some embodiments of the present disclosure, each of the pixels 02 includes a pixel circuit and a light emitting element that are coupled to each other, and the pixel circuit is configured to drive the light emitting element to emit light. That is, the light emission of each of the pixels 02 indicates the light emission of the light emitting element in the pixel 02. In addition, structures of the pixel circuits in the pixels 02 are identical, e.g., the 7T1C (including seven transistors and one capacitor) structure.

The seven transistors at least include: a data writing transistor, a compensation transistor, and a light emission control transistor. The data writing transistor and the compensation transistor are both configured to receive the gate drive signal, and the light emission control transistor is configured to receive the light emission control signal. Moreover, the data writing transistor is further configured to receive a data signal. The seven transistors transmit, in response to the received signals, a light emission drive signal (e.g., a drive current) to the light emitting element to drive the light emitting element to emit light.

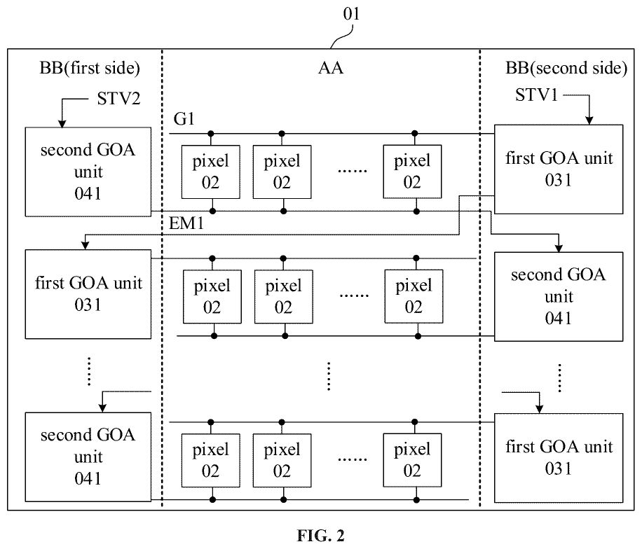

Optionally, FIG. 2 is a schematic structural diagram of another display panel according to some embodiments of the present disclosure. Referring to FIG. 2, in the plurality of first GOA units 031 according to some embodiments of the present disclosure, a portion of the first GOA units 031 are disposed on a first side of the two sides, and the first GOA units 031 other than the portion of the first GOA units 031 are disposed on a second side of the two sides. In the plurality of second GOA units 041, a portion of the second GOA units 041 are disposed on the first side, and the second GOA units 041 other than the portion of the second GOA units 041 are disposed on the second side. That is, in the two sides of the row direction, any side includes one or more of the first GOA units 031 and one or more of the second GOA units 041.

In this case, as illustrated in FIG. 2, the first side refers to the left side of the display region AA, and the second side refers to the right side of the display region AA. In some embodiments, for the structure illustrated in FIG. 2, the first side refers to the right side of the display region AA, and accordingly, the second side refers to the left side of the display region AA.

The longer the length of a signal line, the greater the load on the signal line. The greater the load, the greater the loss of the signal transmitted over the signal line. Therefore, a duration of the gate drive signal transmitted by each of the first GOA units 031 to each of the pixels 02 disposed in a same row with the first GOA units 031 becomes shorter at an end proximal to the first GOA circuit 03 and at an end distal from the first GOA circuit 03. The duration of the gate drive signal indicates a duration of an effective potential used for making the pixel 02 illuminated. In a case that the duration of the effective potential of the gate drive signal is shorter, the pixel 02 receiving the gate drive signal is not capable of being started sufficiently, which refers to an on degree of a transistor for directly receiving the gate drive signal in the pixel 02. As a result, the data signal is not capable of being written effectively, that is, the lower the data signal received by the pixel 02, the higher the luminance of the pixel 02. Conversely, the longer the duration of the effective potential of the gate drive signal, the lower the luminance of the pixel 02. The same applies to the second GOA circuit 04, which is not repeated herein.

In this way, using the first GOA circuit 03 as an example, in a case that each of the first GOA units 031 in the first GOA circuit 03 are disposed on a same side, for any row of pixels in the plurality of rows of pixels, the duration of the effective potential of the gate drive signal received by each of the pixels 02 of the end near the first GOA circuit 03 is less than the duration of the effective potential of the gate drive signal received by each of the pixels 02 of the end distal from the first GOA circuit 03. As a result, along a direction from the end near the first GOA circuit 03 to the end distal from the GOA circuit 03, the luminance of each row of pixels has a gradient phenomenon that the luminance is brighter and brighter. The luminance gradient phenomenon leads to a macroscopic display defect (mura) occurring in the display panel, and the display panel displays an abnormity.

However, in some embodiments of the present disclosure, by disposing a portion of the first GOA units 031 and a portion of the second GOA units 041 on the first side, and another portion of the first GOA units 031 and another portion of the second GOA units 041 on the second side, along a direction from the first side to the second side, the luminance of each row of pixels in a portion of the plurality of rows of pixels progressively decreases, and the luminance of each row of pixels in another portion progressively becomes higher. In this way, the macroscopic display mura is eliminated visually, and thus a display effect of the display panel is great. That is, by disposing at least one of the first GOA units 031 and at least one of the second GOA units 041 respectively on the two sides in the row direction of the plurality of row of pixels, and by disposing any side to include both the first GOA unit 031 and the second GOA unit 041, the macroscopic display mura of the display panel is solved while facilitating the implementation of the superlative narrow frame, and thus the display effect of the display panel is great.

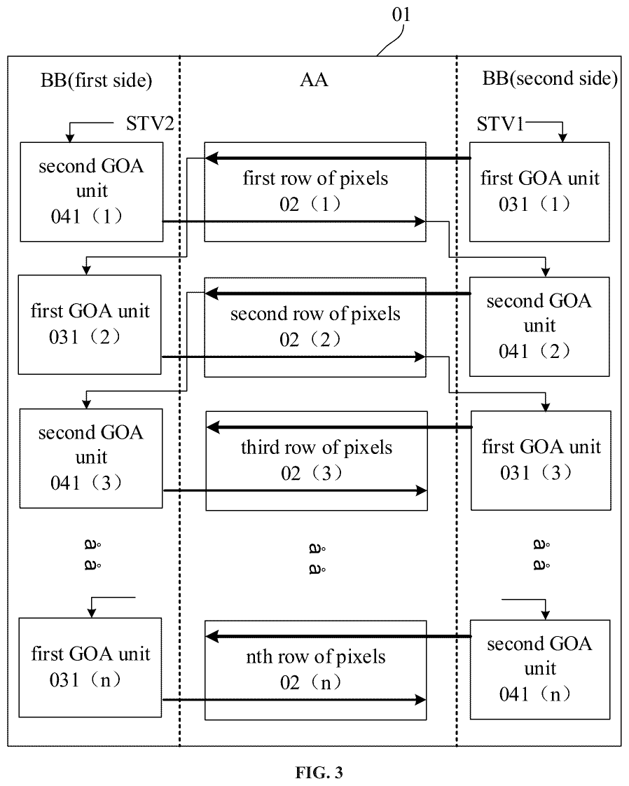

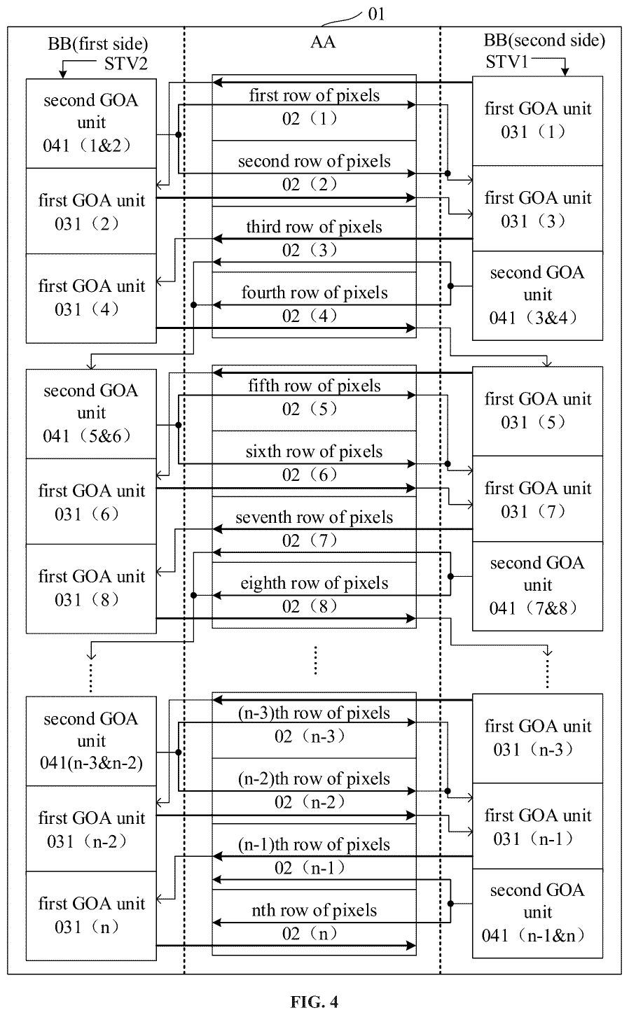

Optionally, description is given using a scenario where any side of the two sides in the row direction includes the first GOA unit 031 and the second GOA unit 031 as an example. FIG. 3 is a schematic structural diagram of still another display panel according to some embodiments of the present disclosure. FIG. 4 is a schematic structural diagram of still another display panel according to some embodiments of the present disclosure.

Referring to FIG. 3 and FIG. 4, each of the first GOA units 031 is only coupled to a row of pixels. In the plurality of first GOA units 031 according to some embodiments of the preset disclosure, each of the first GOA units 031 coupled to an even row of pixels is disposed on the first side, and each of the first GOA units 031 coupled to an odd row of pixels is disposed on the second side.

As an optional implementation, each of the second GOA units 041 is only coupled to a row of pixels. Based on this, referring to FIG. 3, in the plurality of second GOA units 041 according to some embodiments of the present disclosure, each of the second GOA units 041 coupled to an odd row of pixels is disposed on the first side, and each of the second GOA units 041 coupled to an even row of pixels is disposed on the second side.

That is, each of the first GOA units 031 coupled to the odd row of pixels and each of the first GOA units 031 coupled to the even row of pixels are arranged staggered on the two sides of the row direction; and each of the second GOA units 041 coupled to the odd row of pixels and each of the second GOA units 041 coupled to the even row of pixels are arranged staggered on the two sides of the row direction. Each of the first GOA units 031 coupled to the odd row of pixels and each of the second GOA units 041 coupled to the even row of pixels are disposed on a same side; and each of the first GOA units 031 coupled to the even row of pixels and each of the second GOA units 041 coupled to the odd row of pixels are disposed on a same side.

It should be noted that, in this implementation, each of the first GOA units 031 and each of the second GOA units 041 are both only coupled to a row of pixels to drive the row of pixels to emit light, and thus the implementation is referred to as a drive method in a one-push-one mode.

Optionally, still referring to FIG. 3, on the basis of this staggered arrangement, each of the first GOA units 031 and each of the second GOA units 041 that are disposed on the first side are successively arranged in the column direction in an order of one first GOA unit 031 followed by one second GOA unit 041; and each of the first GOA units 031 and each of the second GOA units 041 that are disposed on the second side are successively arranged in the column direction in an order of one second GOA unit 041 followed by one first GOA unit 031.

That is, the first GOA unit 031 and the second GOA unit 041 are staggered arranged on the two sides in an order of the odd row followed by the even row. In other words, using an example in which the display panel includes n rows of pixels, each of the second GOA units 041 coupled to a first row of pixels, a third row of pixels, a fifth row of pixels, . . . , and a 2i+1^{th} row of pixels are disposed on the left side of the display region AA; and each of the first GOA units 031 coupled to the first row of pixels, the third row of pixels, the fifth row of pixels, . . . , and the 2i+1^{th} row of pixels are disposed on the right side of the display region AA. Each of the second GOA units 041 coupled to a second row of pixels, a fourth row of pixels, a sixth row of pixels, . . . , and a 2i^{th} row of pixels are disposed on the right side of the display region AA; and each of the first GOA units 031 coupled to the second row of pixels, the fourth row of pixels, the sixth row of pixels, . . . , and the 2i^{th} row of pixels are disposed on the left side of the display region AA. i is a positive integer less than n.

Exemplarily, FIG. 3 only schematically illustrates a first row of pixels 02(1), a second row of pixels 02(2), a third row of pixels 02(3), and an n^{th} row of pixels 02(n), and also illustrates a first first GOA unit 031(1) and a first second GOA unit 041(1) that are coupled to the first row of pixels 02(1), a second first GOA unit 031(2) and a second second GOA unit 041(2) that are coupled to the second row of pixels 02(2), a third first GOA unit 031(3) and a third second GOA unit 041(3) that are coupled to the third row of pixels 02(3), an n^{th} first GOA unit 031(n) and an n^{th} second GOA unit 041(n) that are coupled to the n^{th} row of pixels 02(n).

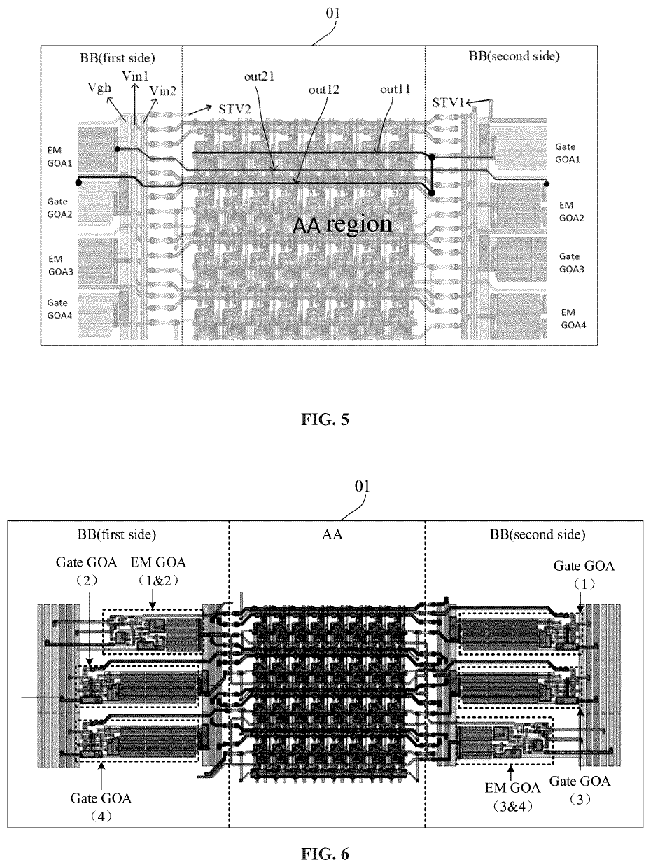

Optionally, using the structure illustrated in FIG. 3 as an example, FIG. 5 is a structural layout of a display panel including a first row of pixels to a fourth row of pixels. EM GOA1 indicates the first second GOA unit 041 (1) coupled to the first row of pixels, EM GOA2 indicates the second second GOA unit 041(2) coupled to the second row of pixels, EM GOA3 indicates the third second GOA unit 041(3) coupled to the third row of pixels, and EM GOA4 indicates a fourth second GOA unit 041(4) coupled to the fourth row of pixels. Gate GOA1 indicates the first first GOA unit 031(1) coupled to the first row of pixels, Gate GOA2 indicates the second first GOA unit 031(2) coupled to the second row of pixels, Gate GOA3 indicates the third first GOA unit 031(3) coupled to the third row of pixels, and Gate GOA4 indicates a fourth first GOA unit 031(4) coupled to the fourth row of pixels.

Referring to FIG. 5, each of the second GOA units 041 (including the EM GOA1 and the EM GOA3 in the figure) coupled to the odd row of pixels and each of the first GOA units 031 (including the Gate GOA2 and the Gate GOA4 in the figure) coupled to the even row of pixels are disposed on the first side; and each of the first GOA units 031 (including the Gate GOA1 and the Gate GOA3 in the figure) coupled to the odd row of pixels and each of the second GOA units 041 (including the EM GOA2 and the EM GOA4 in the figure) coupled to the even row of pixels are disposed on the second side.

In addition, referring to FIG. 5, each of the first GOA units 031 includes two first output terminals out11 and out12. The first output terminal out11 is coupled to a row of pixels disposed in the display region AA. The first output terminal out12 is coupled across the display region AA to one of the cascaded first GOA units 031 and is configured to provide an input signal and a reset signal to the one of the cascaded first GOA units 031 to drive this first GOA unit 031 to operate reliably. That is, each Gate GOA outputs two signals, one of the two signals is used as the gate drive signal for a row of pixels, and the other of the two signals is used as the reset signal for another row of pixels. Each of the second GOA units 041 includes a second output terminal out21, and the second output terminal out21 is coupled to a row of pixels and one of the cascaded second GOA units 041 and is configured to provide the input signal to the one of the cascaded second GOA units 041 to drive this second GOA unit 041 to operate reliably.

For example, referring to FIG. 5, the second output terminal out21 of the EM GOA1 disposed on the left side is coupled to the first row of pixels and is coupled to the EM GOA2 disposed on the right side. The second output terminal out21 of the EM GOA2 disposed on the right side is coupled to the second row of pixels and is coupled to the EM GOA3 disposed on the left side. The second output terminal out21 of the EM GOA3 disposed on the left side is coupled to the third row of pixels and is coupled to the EM GOA4 disposed on the right side. The EM GOA4 disposed on the right side is coupled to the fourth row of pixels, and the like.

The first output terminals out11 of the Gate GOA1 disposed on the right side is coupled to the first row of pixels, and the first output terminals out12 is coupled to the Gate GOA2 disposed on the left side. The first output terminals out11 of the Gate GOA2 disposed on the left side is coupled to the second row of pixels, and the first output terminals out12 is coupled to the Gate GOA3 disposed on the right side. The first output terminals out11 of the Gate GOA3 disposed on the right side is coupled to the third row of pixels, and the first output terminals out12 is coupled to the Gate GOA4 disposed on the left side. The first output terminals out11 of the Gate GOA4 disposed on the left side is coupled to the fourth row of pixels, and the like.

In addition, FIG. 5 illustrates the first start signal terminal STV1 coupled to the first GOA circuit 03 by the first first GOA unit 031 (i.e., the Gate GOA1 illustrated in the figure), the second start signal terminal STV2 coupled to the second GOA circuit 04 by the first second GOA unit 042 (i.e., the EM GOA1 illustrated in the figure), and other drive signal lines for light emission coupled to pixels. The drive signal lines include: a drive power supply line Vgh, a first reset signal line Vin1, and a second reset signal line Vin2. Each of the pixels reliably emits light driven by the signal provided by each of the coupled signal lines.

As another optional implementation, each of the second GOA units 041 is coupled to a group of pixels, which includes two rows of pixels, to drive the two rows of pixels to emit light. Accordingly, a drive method of the second GOA unit 041 is referred to as the drive method in a one-push-two mode. For example, referring to FIG. 4, a group of pixels therein includes two adjacent rows of pixels. That is, each of the second GOA units 041 is coupled to two adjacent rows of pixels. In this way, the wiring is simplified. On this basis, referring to FIG. 4, in the plurality of second GOA units 041 according to some embodiments of the present disclosure, each of the second GOA units 041 coupled to an odd group of pixels is disposed on the first side, and each of the second GOA units 041 coupled to an even group of pixels is disposed on the second side.

Optionally, referring to FIG. 1 and FIG. 4, for the structure illustrated in FIG. 4, each of the first GOA units 031 and each of the second GOA units 041 that are disposed on the first side are successively arranged in the column direction in an order of one second GOA unit 041 followed by two first GOA units 031; and each of the first GOA units 031 and each of the second GOA units 041 that are disposed on the second side are successively arranged in the column direction in an order of two first GOA units 031 followed by one second GOA unit 041.

Optionally, description is given using a scenario where the display panel includes n rows of pixels, and a group of pixels includes two adjacent rows of pixels. FIG. 4 only schematically illustrates the first row of pixels 02(1) to an eighth row of pixels 02(8), and an n−3^{th} row of pixels 02(n−3) to the n^{th} row of pixels 02(n).

The FIG. 4 further illustrates the first second GOA unit 041(1&2) coupled to the first row of pixels 02(1) and the second row of pixels 02(2), the first first GOA unit 031(1) and the second first GOA unit 031(2) that are respectively coupled to the first row of pixels 02(1) and the second row of pixels 02(3), the second second GOA unit 041(3&4) coupled to the third row of pixels 02(3) and the fourth row of pixels 02(4), the third first GOA unit 031(3) and the fourth first GOA unit 031(4) that are respectively coupled to the third row of pixels 02(3) and the fourth row of pixels 02(4), the third second GOA unit 041(5&6) coupled to a fifth row of pixels 02(5) and a sixth row of pixels 02(6), a fifth first GOA unit 031(5) and a sixth first GOA unit 031(6) that are respectively coupled to the fifth row of pixels 02(5) and the sixth row of pixels 02(6), the fourth second GOA unit 041(7&8) coupled to a seventh row of pixels 02(7) and the eighth row of pixels 02(8), a seventh first GOA unit 031(7) and an eighth first GOA unit 031(8) that are respectively coupled to the seventh row of pixels 02(7) and the eighth row of pixels 02(8), the second GOA unit 041(n−3&n−2) coupled to the n−3^{th} row of pixels 02(n−3) and an n−2^{th} row of pixels 02(n−2), an n−3^{th} first GOA unit 031(n−3) and an n−2^{th} first GOA unit 031(n−2) that are respectively coupled to the n−3^{th} row of pixels 02(n−3) and the n−2^{th} row of pixels 02(n−2), the second GOA unit 041(n−1&n) coupled to an n−1^{th} row of pixels 02(n−1) and the n^{th} row of pixels 02(n), and an n−1^{th} first GOA unit 031(n−1) and the n^{th} first GOA unit 031(n) that are respectively coupled to the n−1^{th} row of pixels 02(n−1) and the n^{th} row of pixels 02(n).

Referring to FIG. 4, the first second GOA unit 041 to the last second GOA unit 041 are staggered on the two sides of the row direction. One of the second GOA units 041 coupled to two adjacent rows of pixels and two of the first GOA units 031 are organized into a group and arranged on the two sides in accordance with an arrangement of left side, right side, and left side.

Using the structure illustrated in FIG. 4 as an example, FIG. 6 is a structural layout of another display panel including the first row of pixels to the fourth row of pixels. The EM GOA(1&2) indicates the second GOA unit 041(1&2) coupled to the first row of pixels and the second row of pixels, the EM GOA(3&4) indicates the second GOA unit 041(3&4) coupled to the third row of pixels and the fourth row of pixels, the Gate GOA1 indicates the first first GOA unit 041(1) coupled to the first row of pixels, the Gate GOA2 indicates the second first GOA unit 041(2) coupled to the second row of pixels, the Gate GOA3 indicates the third first GOA unit 041(3) coupled to the third row of pixels, and the Gate GOA4 indicates the fourth first GOA unit 041(4) coupled to the fourth row of pixels.

Referring to FIG. 6, the second GOA unit 041 coupled to the odd group of pixels (including a first group of pixels consisting of the first row of pixels and the second row of pixels), that is, the EM GOA (1&2), and each of the first GOA units 031 (including the Gate GOA2 and the Gate GOA4 in the figure) coupled to the even row of pixels are disposed on the first side. The second GOA unit 041 coupled to the even group of pixels (including a second group of pixels consisting of the third row of pixels and the fourth row of pixels), that is, the EM GOA (3&4), and each of the first GOA units 031 (including the Gate GOA1 and the Gate GOA3 in the figure) coupled to the odd row of pixels are disposed on the second side. That is, in the column direction, an arrangement of EM GOA, Gate GOA, and Gate GOA is used on the first side (i.e., a left frame); and an arrangement of Gate GOA, Gate GOA, and EM GOA is used on the second side (i.e., a right frame).

In addition, referring to FIG. 6, the Gate GOA1 disposed on the left side, in one aspect, is coupled to a row of pixels, and in another aspect, is coupled to the Gate GOA1 disposed on the right side and is configured to provide the input signal to the Gate GOA2 to drive the Gate GOA2 to operate reliably, and the like. The EM GOA(1&2) disposed on the right side, in one aspect, is coupled to a row of pixels, and in another aspect, is coupled to the EM GOA(3&4) disposed on the left side and is configured to provide the input signal to the EM GOA(3&4) to drive the EM GOA(3&4) to operate reliably, and the like. In addition, in conjunction with the above embodiments, the Gate GOA1 is coupled to the first start signal terminal STV1 and reliably operates in response to the first start signal transmitted by the first start signal terminal STV1. The EM GOA(1&2) is coupled to the second start signal terminal STV2 and reliably operates in response to the second start signal transmitted by the second start signal terminal STV2.

Optionally, in some embodiments of the present disclosure, the pixel and each circuit in the display panel include: an active layer (poly) P1, a first gate metal layer gate1, a second gate metal layer gate2, a first source-drain metal layer SD1, and a second source-drain metal layer SD2 that are disposed on a side of the substrate 01 and successively stacked. In some embodiments, a positional relationship between the layers is not limited to the description in the embodiments of the present disclosure.

A signal line corresponding to the first start signal terminal STV1 described above and the first gate metal layer gate1 are disposed in a same layer, and a signal line corresponding to the second start signal terminal STV2 described above and the second gate metal layer gate2 are disposed in a same layer. The first gate line G1 and the light emission control line EM1 are both disposed in the same layer with the first gate metal layer gate1. The first GOA unit 031 is transferred to the first gate metal layer gate1 by the second gate metal later gate2 to be coupled to the first gate line G1. The second GOA unit 041 is transferred to the first gate metal layer gate1 by the second gate metal later gate2 to be coupled to the light emission control line EM1. Transfer portions and the second source-drain metal layer SD2 are disposed in a same layer. The drive power supply line Vgh, the first reset signal line Vin1, and the second reset signal line Vin2 are disposed in a same layer with the first source-drain metal layer SD1. The first reset signal line Vin1 and the second reset signal line Vin2 are disposed in the same layer with the second source-drain metal layer SD2.

The term “disposed in a same layer” indicates: a layer structure formed by forming a film layer for forming a specific pattern using a same film forming process and then patterning the film layer by a one-time patterning process using a same mask. According to different specific patterns, the one-time patterning process includes multiple exposures, development, or etching processes, and the specific patterns of the formed layer structure is continuous or not. That is, a plurality of elements, components, structures and/or parts are made of same materials and are formed by the same one-time patterning process. In this way, the manufacturing process and costs is saved, and the manufacturing efficiency is accelerated.

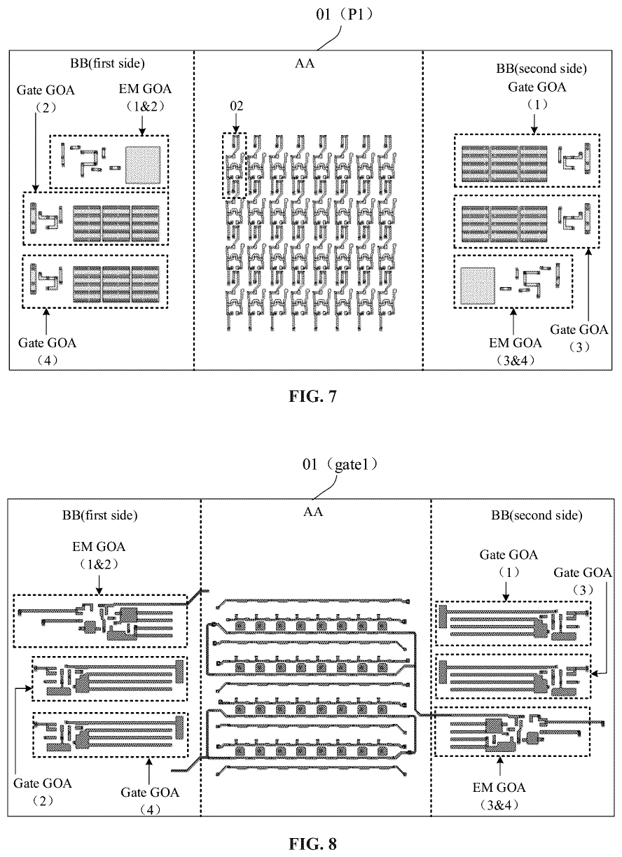

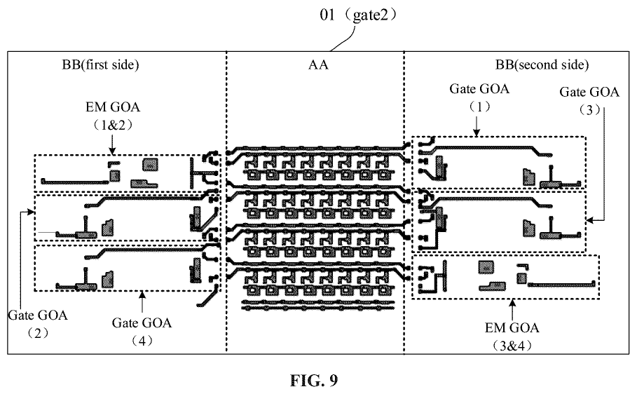

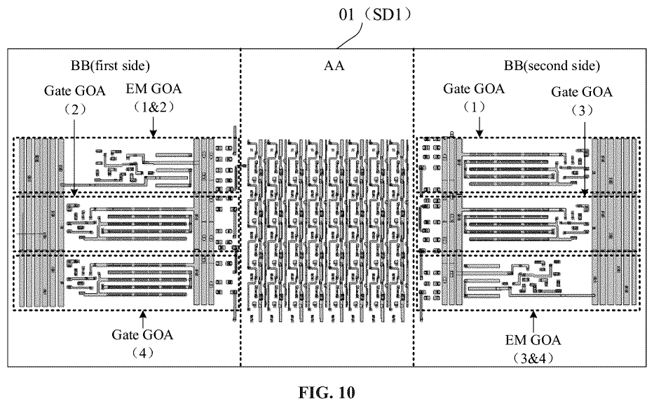

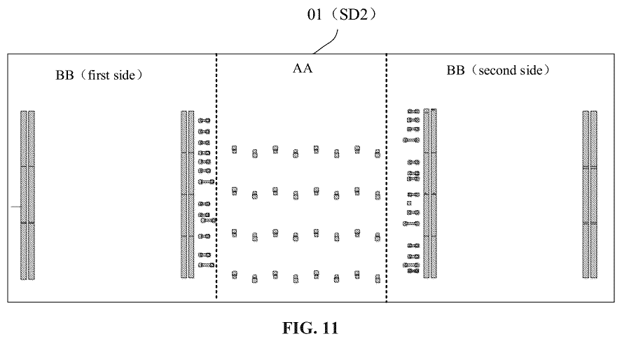

Exemplarily, using the structure illustrated in FIG. 6 as an example, FIG. 7 is a structural layout of an active layer P1 in a display panel, FIG. 8 is a structural layout of a first gate metal layer gate1 in a display panel, FIG. 9 is a structural layout of a second gate metal layer gate2 i in a display panel, FIG. 10 is a structural layout of a first source-drain metal layer SD1 in a display panel, and FIG. 11 is a structural layout of a second source-drain metal layer SD2 in a display panel.

Optionally, in some embodiments of the present disclosure, each of the pixels 02 includes an N-type transistor and a P-type transistor. As described above, it indicates that the pixels circuit in each of the pixels 02 includes the N-type transistor and the P-type transistor. The N-type transistor is made of an oxide material, and the P-type transistor is made of a low-temperature polysilicon (LTPS) material. That is, the display panel according to some embodiments of the present disclosure is a low-temperature polycrystalline oxide (LTPO) display panel. The material of the transistor is the material of the active layer P1 in the transistor.

It should be noted that, the N-type transistor and the P-type transistor herein are transistors for receiving the gate drive signal. A difference between the N-type transistor and the P-type transistor is not present in a transistor for receiving the light emission control signal. That is, each of the pixels 02 only includes a type of transistors for receiving the light emission control signal. In conjunction with the embodiments described above, the data writing transistor of the pixel circuit in each of the pixels 02 is the P-type transistor, and the light emission control transistor and the compensation transistor are the N-type transistors.

For the N-type transistor, an effective potential is a high potential relative to an invalid potential. That is, the N-type transistor is conducted and operates effectively in response to the high potential. For the P-type transistor, an effective potential is a low potential relative to an invalid potential. That is, the P-type transistor is conducted and operates effectively in response to the low potential. In other words, the N-type transistor and the P-type transistor conduct and operate effectively in response to different potentials. Therefore, it is necessary to arrange two types of GOA units which output the gate drive signals with effective potentials of high and low potentials to drive the pixel 02 to be lightened.

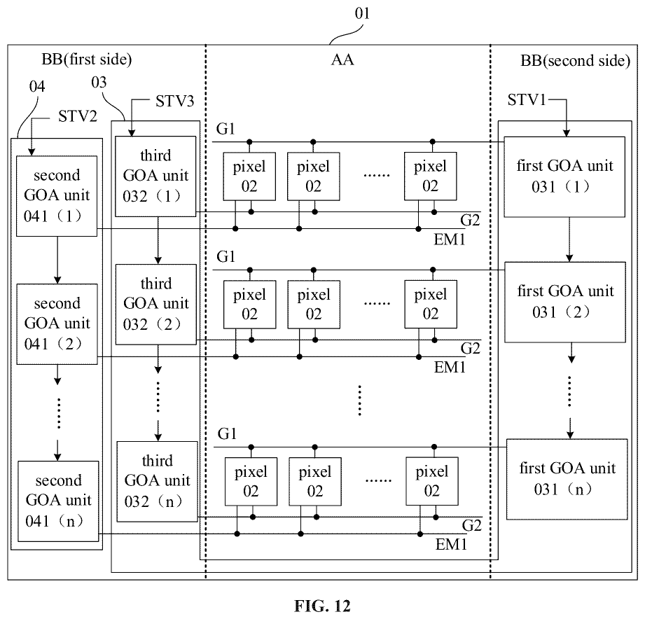

Referring to the schematic structural diagram of the still another display panel illustrated in FIG. 12, on the basis that each of the pixels 02 includes the N-type transistor and the P-type transistor, the first GOA circuit 03 further includes: a plurality of cascaded third GOA units 032. For the cascading method, reference is made to the embodiments described above, which is not repeated herein.

Each of the first GOA units 031 is coupled to the P-type transistor included in each of the pixels 02 in at least one row of pixels and is configured to transmit the first gate drive signal to the P-type transistor. As described above, each of the first GOA units 031 herein is coupled to a row of pixels by one of the first gate lines G1.

Each of the third GOA units 032 is coupled to the N-type transistor included in each of the pixels 02 in at least one row of pixels and is configured to transmit the second gate drive signal to the N-type transistor. That is, a Gate GOA circuit that controls the operation of the N-type transistor is added for the LTPO display panel.

Optionally, referring to FIG. 12, the display panel further includes: a plurality of second gate lines G2 disposed in the display region. Each of the third GOA units 032 is coupled to a row of pixels by one of the second gate lines G2. The plurality of cascaded third GOA units 032 are coupled to a third start signal terminal STV3 and are configured to transmit, in response to a second start signal transmitted by the third start signal terminal STV3, the second gate drive signal to the plurality of rows of pixels. To facilitate the wiring, in the plurality of cascaded third GOA units 032 illustrated in FIG. 12, a first third GOA unit 032 coupled to the first row of pixels is coupled to the third start signal terminal STV3.

Optionally, the second gate line G2 and the first gate metal layer gate1 are disposed in the same layer. A signal line corresponding to the third start signal terminal STV3 is disposed in the same layer with the first gate metal layer gate1 or the second gate metal layer gate2.

The Gate GOA circuit for driving the operation of the P-type transistor is required to be coupled to more signal lines relative to the Gate GOA circuit and the EM GOA circuit for driving the operation of the N-type transistor, and therefore, in some embodiments of the present disclosure, a size of the third GOA unit 032 and a size of the second GOA unit 041 are identical, and are both smaller than a size of the first GOA unit 031. In addition, a structure of the third GOA unit 032 and a structure of the second GOA unit 041 are also identical and are both different from a structure of the first GOA unit 031.

Exemplarily, the first GOA unit 031 is typically the 8T2C structure, and the second GOA unit 041 and the third GOA unit 032 are typically the 10T3C structure.

Based on this, referring to FIG. 12, in some embodiments of the present disclosure, the plurality of second GOA units 041 and the plurality of third GOA units 032 are disposed on the first side of the two sides, and the plurality of first GOA units 031 are disposed on the second side of the two sides. That is, the plurality of second GOA units 041 and the plurality of third GOA units 032 are disposed on the same side and are arranged opposite to the plurality of first GOA units 031.

As an optional implementation, referring to FIG. 12, each of the second GOA units 041 is coupled to a row of pixels, and each of the third GOA units 032 is coupled to a row of pixels. The second GOA unit 041 and the third GOA unit 032 that are coupled to a same row of pixels are successively arranged along the row direction. Therefore, the second GOA units 041 in the second GOA circuit 04 are disposed on a same side and successively arranged along the column direction. The first GOA units 031 in the first GOA circuit 03 are disposed on a same side and successively arranged along the column direction. The third GOA units 032 in the third GOA circuit 03 are disposed on a same side and successively arranged along the column direction.

For example, FIG. 12 respectively illustrates the first second GOA unit 041(1), the first third GOA unit 032(1), and the first first GOA unit 031(1) that are coupled to the first row of pixels; the second second GOA unit 041(2), a second third GOA unit 032(2), and the second first GOA unit 031(2) that are coupled to the second row of pixels; and the n^{th} second GOA unit 041(n), an n^{th} third GOA unit 032(n), and the n^{th} first GOA unit 031(n) that are coupled to the n^{th} row of pixels. Using the first row of pixels as an example, the first second GOA unit 041(1) and the first third GOA unit 032(1) that are coupled to the first row of pixels are disposed on the first side, and the first first GOA unit 031(1) is disposed on the second side, and the first second GOA unit 041(1), the first third GOA unit 032(1), and the first first GOA unit 031(1) are successively arranged along the direction from the first side to the second side.

The Gate GOA circuit for driving the operation of the N-type transistor is identified as a GOA_N circuit, and the Gate GOA circuit for driving the operation of the P-type transistor is identified as a GOA_P circuit. For the solution illustrated in FIG. 12, it is understood that the GOA_N circuit and the EM GOA circuit are disposed on a same side (e.g., the left side) and the GOA_P circuit is separately disposed on a side (e.g., the right side) to perform a unilateral drive on the plurality of rows of pixels. In this way, the layout space of the display panel is reasonably utilized, thus facilitating the narrow frame design of the display panel.

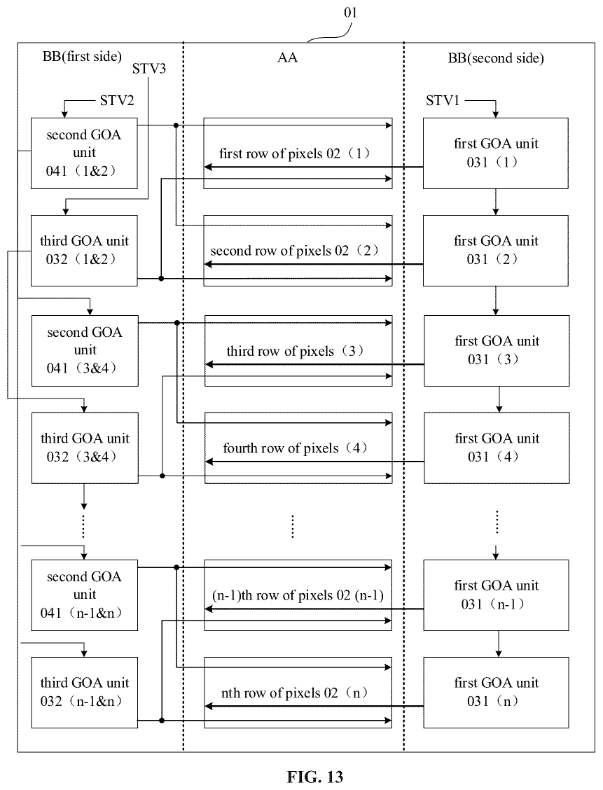

As another optional implementation, referring to the schematic structural diagram of still another display panel illustrated in FIG. 13, in some embodiments of the present disclosure each of the second GOA units 041 is coupled to two rows of pixels, and each of the third GOA units 032 is coupled to two rows of pixels. That is, a drive method of the second GOA unit 041 and a drive method of the third GOA unit 032 are both referred to as the drive method in the one-push-two mode.

Exemplarily, each of the second GOA units 041 is coupled to two adjacent rows of pixels, and each of the third GOA units 032 is coupled to two adjacent rows of pixels. Each adjacent one of the second GOA units 041 and one of the third GOA units 032 are coupled to the same two rows of pixels. In this way, the wiring is further simplified.

In addition, referring to FIG. 13, each of the second GOA units 041 and each of the third GOA units 032 that are disposed on the first side are arranged in the column direction in an order of one second GOA unit 041 followed by one third GOA unit 032, that is, are staggered arranged in an order of one second GOA unit 041 followed by one third GOA unit 032.

Description is given using a scenario where the display panel includes n rows of pixels, and each of the second GOA units 041 and each of the third GOA units 032 are simultaneously coupled to the same two adjacent rows of pixels as an example. Referring to FIG. 13, FIG. 13 schematically illustrates the first row of pixels 02(1) to the fourth row of pixels 02(4), the n−1^{th} row of pixels 02(n−1), and the n^{th} row of pixels 02(n). FIG. 13 further illustrates the second GOA unit 041(1&2) and the third GOA unit 032(1&2) that are coupled to the first row of pixels 02(1) and the second row of pixels 02(2), the first first GOA unit 031(1) and the second first GOA unit 031(2) that are respectively coupled to the first row of pixels 02(1) and the second row of pixels 02(2), the second GOA unit 041(3&4) and the third GOA unit 032(3&4) that are coupled to the third row of pixels 02(3) and the fourth row of pixels 02(4), the third first GOA unit 031(3) and the fourth first GOA unit 031(4) that are respectively coupled to the third row of pixels 02(3) and the fourth row of pixels 02(4), the second GOA unit 041(n−1&n) and the third GOA unit 032(n−1&n) that are coupled to the n−1^{th} row of pixels 02(n−a) and the n^{th} row of pixels 02(n), and the n−1^{th} first GOA unit 031(n−1) and the n^{th} first GOA unit 031(n) that are respectively coupled to the n−1^{th} row of pixels 02(n−1) and the n^{th} row of pixels 02(n).

Referring to FIG. 13, in the column direction, the second GOA unit 041(1&2), the third GOA unit 032(1&2), the second GOA unit 041(3&4), and the third GOA unit 032(3&4) are successively arranged and disposed on the first side. The first first GOA unit 031(1) to the n^{th} first GOA unit 031(n) are successively arranged and disposed on the second side. Relative to the arrangement in FIG. 12, the arrangement in FIG. 13 further simplifies the layout, and thus facilitates a narrow frame design of the display panel.

It should be noted that, the arrangement position of each GOA unit described above is illustrated for ease of description, and any solution facilitating the narrow frame design is applicable to the embodiments of the present disclosure.

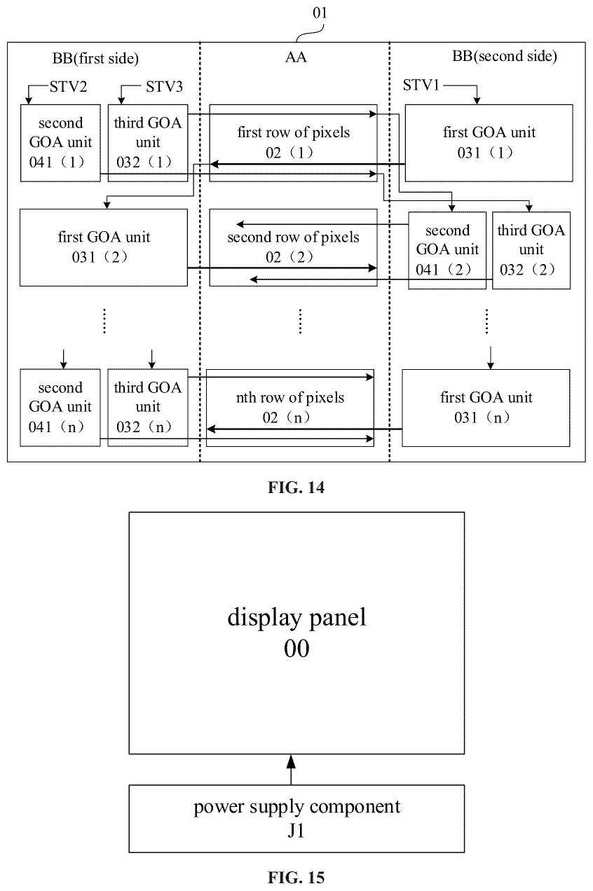

For example, in conjunction with the structures of FIG. 3 and FIG. 12, description is given using a scenario where the display panel includes n rows of pixels as an example. FIG. 14 is a schematic structural diagram of still another display panel according to some embodiments of the present disclosure. Referring to FIG. 14, on the basis that the second GOA unit 041 and the third GOA unit 032 are both driven in the one-push-one mode, the second GOA unit 041 and the third GOA unit 032 that are coupled to the odd row of pixels are disposed on the first side, and the second GOA unit 041 and the third GOA unit 032 that are coupled to the even row of pixels are disposed on the second side. The first GOA unit 031 coupled to the odd row of pixels are disposed on the second side, and the first GOA unit 031 coupled to the even row of pixels are disposed on the first side. The second GOA unit 041 and the third GOA unit 032 that are coupled to the same row of pixels are arranged along the row direction. In this way, in conjunction with the above embodiments, this arrangement further improves the macroscopic mura phenomenon of the display panel on the premise of simplifying the layout.

FIG. 14 only schematically illustrates the first row of pixels 02(1), the second row of pixels 02(2), the n^{th} row of pixels 02(n), the second GOA unit 041(1), the third GOA unit 032(1), and the first GOA unit 031(1) that are coupled to the first row of pixels 02(1), the second GOA unit 041(2), the third GOA unit 032(2), and the first GOA unit 031(2) that are coupled to the second row of pixels 02(2), and the second GOA unit 041(n), the third GOA unit 032(n), and the first GOA unit 031(n) that are coupled to the n^{th} row of pixels 02(n).

In some embodiments of the present disclosure, the first GOA unit 031, the second GOA unit 041, and the third GOA unit 032 all include: a drive transistor and an output transistor.

The drive transistor is coupled to the output transistor, and the output transistor is coupled to the pixel. The drive transistor is configured to control the output transistor to transmit signals to the pixel. A channel width-length ratio W/L of the output transistor is greater than a channel width-length ratio of the drive transistor. That is, the channel width-length ratio W/L of the output transistor is greater, such that the output drive capability of the GOA unit is improved, and thus the macroscopic mura phenomenon of the display panel is further improved.

For example, the channel width-length ratio W/L of the output transistor is twice the channel width-length ratio of the drive transistor. For example, a channel width W of the drive transistor is 120, and a channel width of the output transistor W is 240.

It should be noted that, the arrangement of the channel width-length ratio therein is mainly for the GOA unit corresponding to the one-push-two drive mode (e.g., the second GOA unit 041 and the third GOA unit 032 illustrated in FIG. 13), and of course, for the GOA unit corresponding to the one-push-one drive mode (e.g., the first GOA unit 031).

In summary, some embodiments of the present disclosure provide a display panel. The display panel includes: the substrate including the display region and the GOA region, the plurality of pixels disposed in the display region, and the first GOA circuit and the second GOA circuit that are disposed in the GOA region. The plurality of first GOA units included in the first GOA circuit and the plurality of second GOA units included in the second GOA circuit are respectively coupled to the plurality of rows of pixels to drive the plurality of rows of pixels to emit light. At least one of the first GOA units and at least one of the second GOA units are respectively disposed on the two sides of the plurality of rows of pixels in the row direction, and therefore, the layout is simplified to ensure that the screen-to-body ratio of the display panel is great, which facilitates the narrow frame design of the display device.

FIG. 15 is a schematic structural diagram of a display device according to some embodiments of the present disclosure. Referring to FIG. 15, the display device includes: a power supply component J1, and the display panel 00 as described in any of FIG. 1 to FIG. 14.

The power supply component J1 is coupled to the display panel 00 and is configured to supply power to the display panel 00.

Optionally, the display device is: an OLED display device, an AMOLED display device, a smart phone, a tablet, a television, a display, or any other product or component with a display function.

Described above are merely optional embodiments of the present disclosure, and are not intended to limit the present disclosure. Any modifications, equivalent substitutions, improvements, and the like may be made within the protection scope of the present disclosure, without departing from the spirit and principles of the present disclosure.

1. A display panel, comprising:
a substrate, comprising a display region and a gate driver on array region at least partially surrounding the display region;
a plurality of pixels arranged in arrays, disposed in the display region;
a first GOA circuit, disposed in the GOA region, wherein the first GOA circuit comprises a plurality of cascaded first GOA units, each of the first GOA units being coupled to at least one row of the pixels and being configured to transmit a gate drive signal to the at least one row of the pixels; and
a second GOA circuit, disposed in the GOA region, wherein the second GOA circuit comprises a plurality of cascaded second GOA units, each of the second GOA units being coupled to at least one row of the pixels and being configured to transmit a light emission control signal to the at least one row of the pixels;
wherein at least one of the first GOA units and at least one of the second GOA units are respectively disposed on two sides of a plurality of rows of the pixels in a row direction; and each of the pixel is configured to emit light in response to the received gate drive signal and the received light emission control signal.

2. The display panel according to claim 1, wherein
in the plurality of first GOA units, a portion of the first GOA units are disposed on a first side of the two sides, and the first GOA units other than the portion of the first GOA units are disposed on a second side of the two sides; and
in the plurality of second GOA units, a portion of the second GOA units (041) are disposed on the first side, and the second GOA units other than the portion of the second GOA units are disposed on the second side.

3. The display panel according to claim 2, wherein each of the first GOA units is coupled to a row of the pixels;
wherein in the plurality of first GOA units, each of the first GOA units coupled to an even row of the pixels is disposed on the first side, and each of the first GOA units coupled to an odd row of the pixels is disposed on the second side.

4. The display panel according to claim 3, wherein each of the second GOA units is coupled to a row of the pixels;
wherein in the plurality of second GOA units, each of the second GOA units coupled to an odd row of the pixels is disposed on the first side, and each of the second GOA units coupled to an even row of the pixels is disposed on the second side.

5. The display panel according to claim 4, wherein
each of the first GOA units and each of the second GOA units that are disposed on the first side are successively arranged in a column direction in an order of one first GOA unit followed by one second GOA unit; and
each of the first GOA units and each of the second GOA units that are disposed on the second side are successively arranged in the column direction in an order of one second GOA unit followed by one first GOA unit.

6. The display panel according to claim 3, wherein each of the second GOA units is coupled to a group of the pixels, the group of the pixels comprising two rows of the pixels;
wherein in the plurality of second GOA units, each of the second GOA units coupled to an odd group of the pixels are disposed on the first side, and each of the second GOA units coupled to an even group of the pixels are disposed on the second side.

7. The display panel according to claim 6, wherein the group of the pixels comprises two adjacent rows of the pixels.

8. The display panel according to claim 6, wherein
each of the first GOA units and each of the second GOA units that are disposed on the first side are successively arranged in a column direction in an order of one second GOA unit followed by two first GOA units; and
each of the first GOA units and each of the second GOA units that are disposed on the second side are successively arranged in the column direction in an order of two first GOA units followed by one second GOA unit.

9. The display panel according to claim 1, wherein
each of the first GOA units comprises two first output terminals, one of the first output terminals being coupled to a row of the pixels, and the other of the first output terminals being coupled to one of the cascaded first GOA units; and
each of the second GOA units comprises a second output terminal, the second output terminal being coupled to a row of the pixels and one of the cascaded second GOA units.

10. The display panel according to claim 1, wherein each of the pixels comprises an N-type transistor and a P-type transistor; and the first GOA circuit further comprises: a plurality of cascaded third GOA units; wherein
each of the first GOA units is coupled to the P-type transistor in each of the pixels of the at least one row of the pixels and is configured to transmit a first gate drive signal to the P-type transistor; and
each of the third GOA units is coupled to the N-type transistor in each of the pixels of the at least one row of the pixels and is configured to transmit a second gate drive signal to the N-type transistor.

11. The display panel according to claim 10, wherein
a size of the third GOA unit and a size of the second GOA unit are the same, and are both greater than a size of the first GOA unit; and
the plurality of second GOA units and the plurality of third GOA units are disposed on a first side of the two sides, and the plurality of first GOA units are disposed on a second side of the two sides.

12. The display panel according to claim 11, wherein
each of the second GOA units is coupled to a row of the pixels, and each of the third GOA units is coupled to a row of the pixels; and
the second GOA units and the third GOA units that are coupled to a same row of the pixels are successively arranged along the row direction.

13. The display panel according to claim 11, wherein
each of the second GOA units is coupled to two rows of the pixels, and each of the third GOA units is coupled to two rows of the pixels; and
each of the second GOA units and each of the third GOA units that are disposed on the first side are successively arranged in a column direction in an order of one second GOA unit followed by one third GOA unit.

14. The display panel according to claim 13, wherein each of the second GOA units is coupled to two adjacent rows of the pixels, each of the third GOA units is coupled to two adjacent rows of the pixels, and each adjacent one of the second GOA units and one of the third GOA units are coupled to the same two rows of the pixels.

15. The display panel according to claim 13, wherein the second GOA unit and the third GOA unit both comprise: a drive transistor and an output transistor:
wherein the drive transistor is coupled to the output transistor, and the output transistor is coupled to the pixel; and the drive transistor is configured to control the output transistor to transmit a signal to the pixel; and
wherein a channel width-length ratio of the output transistor is greater than a channel width-length ratio of the drive transistor.

16. The display panel according to claim 15, wherein the channel width-length ratio of the output transistor is twice the channel width-length ratio of the drive transistor.

17. The display panel according to claim 10, wherein in each of the pixels, the N-type transistor is made of an oxide material, and the P-type transistor is made of a low-temperature polysilicon (LTPS) material.

18. The display panel according to claim 10, wherein
the plurality of cascaded first GOA units are coupled to a first start signal terminal and are configured to transmit, in response to a first start signal transmitted by the first start signal terminal, the first gate drive signal to the plurality of rows of the pixels;
the plurality of cascaded second GOA units are coupled to a second start signal terminal and are configured to transmit, in response to a second start signal transmitted by the second start signal terminal, the light emission control signal to the plurality of rows of the pixels; and
the plurality of cascaded third GOA units are coupled to a third start signal terminal and are configured to transmit, in response to a second start signal transmitted by the third start signal terminal, the second gate drive signal to the plurality of rows of the pixels.

19. The display panel according to claim 10, further comprising:
a plurality of first gate lines, a plurality of second gate lines, and a plurality of light emission control lines, which are disposed in the display region;
wherein each of the first GOA units is coupled to a row of the pixels by one of the first gate lines, each of the second GOA units is coupled to a row of the pixels by one of the light emission control lines, and each of the third GOA units is coupled to a row of the pixels by one of the second gate lines.

20. A display device, comprising: a power supply component and g display panel;
wherein the power supply component is coupled to the display panel and is configured to supply power to the display panel; and
the display panel comprises:
a substrate, comprising a display region and a gate driver on array region at least partially surrounding the display region;
a plurality of pixels arranged in arrays, disposed in the display region;
a first GOA circuit disposed in the GOA region, wherein the first GOA circuit comprises a plurality of cascaded first GOA units, each of the first GOA units being coupled to at least one row of the pixels and being configured to transmit a gate drive signal to the at least one row of the pixels; and
a second GOA circuit, disposed in the GOA region, wherein the second GOA circuit comprises a plurality of cascaded second GOA units, each of the second GOA units being coupled to at least one row of the pixels and being configured to transmit a light emission control signal to the at least one row of the pixels;
wherein at least one of the first GOA units and at least one of the second GOA units are respectively disposed on two sides of a plurality of rows of the pixels in a row direction; and each of the pixel is configured to emit light in response to the received gate drive signal and the received light emission control signal.
